(19) United States
(12) Patent Application Publication
(10) Pub. No.: US 2023/0064221 A1
(43) Pub. Date: Mar. 2, 2023

(54) LIVE ELECTRONIC CONTENT CUSTOMIZATION

(71) Applicant: Weld North Education LLC, Scottsdale, AZ (US)

(72) Inventors: Ian Michael Lotinsky, Ponte Vedra, FL (US); Ian Phelan Lukens, Rockville, MD (US)

(73) Assignee: Weld North Education LLC, Scottsdale, AZ (US)

(21) Appl. No.: 17/592,008

(22) Filed: Feb. 3, 2022

Related U.S. Application Data
(60) Provisional application No. 63/237,950, filed on Aug. 27, 2021.

(51) Int. Cl. H04L 65/60

(52) U.S. Cl. CPC H04L 65/601

(57) ABSTRACT

Computer-implemented systems and methods for electronically propagating content to downstream users. A content management system is configured to manage storage of a collection of content blocks. Each collection includes multiple layers of content blocks including at least one authoring layer customizable by one or more authors. A content authoring tool enables authors to perform one or more modifications to add, hide, remove or edit content blocks and automatically propagates the author modifications downstream to lower levels accessed by users of the content management system.

This application claims the benefit of U.S. Appl. No. 63/237,950, filed Aug. 27, 2021, incorporated in its entirety be reference herein.

### TECHNICAL FIELD

The field relates to electronic content management.

### RELATED ART

Content management systems generate electronic content for output to users for display, viewing, editing or manipulation. Content management systems can be used with a number of web applications to deliver content for education, business, government, non-profit services, or other applications. Over time, content management systems face challenges in incorporating updates to existing content. These challenges are especially problematic in education where content updates may be driven by requirements made at a federal, state or local level.

For example, changes to curriculum content often occur. These changes may result in updates having to be made to existing content stored in a content management system. Such updates may occur at a relatively high level, such as, new directives issued by a school board or other governing entity, which have to pass downstream to users of a content management system. Downstream users however often have preexisting custom configurations to their respective content. For example, one county or state education system or group of schools may have content configured for their own respective standards which is different than customized configurations carried out by other county or state education systems or schools. Updates generated upstream by a publisher or other education entity cannot be efficiently sent downstream to the different users. Conflicts between the updates and different custom configurations can block or limit propagation of updates downstream. These conflicts can occur due to different data structures or other incompatibilities that arise from the different custom configurations put in place by existing users, such as, different school systems.

Other approaches to managing data updates are limited or inapplicable to the demands of education content. For example, source code control systems and word processor application (such as, Microsoft Office “track changes” feature) require downstream customizers to review and accept changes or conflicting changes manually.

What is needed are electronic content management systems and methods that allow propagation of updates to heterogenous downstream content users.

### BRIEF SUMMARY

Computer-implemented methods, systems and computer-readable storage medium are provided for improved online customization and authoring of content.

In an embodiment, a computer-implemented system for electronically propagating content to downstream users is provided. The system includes a content management system and a content authoring tool. The content management system is configured to manage storage of collections of content blocks. Each collection includes multiple layers of content blocks including at least one authoring layer customizable by one or more authors. The content authoring tool is coupled to the content management system and configured to manage customization of content by authors in the stored collections of content blocks.

In another feature, the content authoring tool is configured to communicate over a network through a web application with a browser at a remote computing device. The content management system updates the stored collection in accordance with the modifications performed through the content authoring tool.

In a further feature, the content authoring tool is configured to enable an author at the remote computing device to perform one or more modifications to a collection to add, remove, hide, or edit content blocks in the at least one authoring layer.

In another feature, for each content block to be added to an authoring layer of a collection, the content authoring tool calculates a rank for each added content block relative to other surrounding content blocks in the collection, and generates predecessor ID and successor ID information for respective predecessor and successor content blocks surrounding the added content block in the same authoring layer.

Further embodiments, features, and advantages of the invention, as well as the structure and operation of the various embodiments of the invention are described in detail below with reference to accompanying drawings.

### BRIEF DESCRIPTION OF THE FIGURES

Embodiments are described with reference to the accompanying drawings. In the drawings, like reference numbers may indicate identical or functionally similar elements. The drawing in which an element first appears is generally indicated by the left-most digit in the corresponding reference number.

FIG. 1 is a diagram of a system having an online platform with a content authoring tool according to an embodiment of the present invention.

FIG. 2 is a flowchart diagram of a routine for multi-layer authoring with customization of content in accordance with an embodiment.

FIG. 3 is a flowchart diagram of a routine for saving blocks in the multi-layer authoring of FIG. 3 in accordance with an embodiment.

FIG. 4 is a flowchart diagram of a routine for rendering each layer of blocks in the multi-layer authoring of FIG. 3 in accordance with an embodiment.

FIG. 5 shows an example data collection stored and rendered in accordance with an embodiment.

### DESCRIPTION

### Electronic Content Management Systems and Methods

Embodiments of the present invention provide electronic content management of content accessed through an application. An application may be a web application accessed through a browser on a computing device or a downloadable application implemented on a computing device. In embodiments, computer-implemented systems and methods perform recursive edits to content in a content management system, while allowing upstream edits to automatically flowthrough to downstream customizations. In this way, an electronic management system allows multiple stakeholders in a content management and publishing chain to automatically customize content, update content, and receive updates without human review.

Embodiments refer to illustrations described herein with reference to particular applications. It should be understood that the invention is not limited to the embodiments. Those skilled in the art with access to the teachings provided herein will recognize additional modifications, applications, and embodiments within the scope thereof and additional fields in which the embodiments would be of significant utility.

In the detailed description of embodiments herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Multi-Layer Authoring of Content Blocks

In an embodiment, a content management system stores digital data which may include, but is not limited to, digital media or other digital representations of physical media. Content is made up of blocks of rich text, images, videos, documents, hyperlinks, and linked or other embedded content from the content management system. Blocks can be added, deleted, edited, and hidden.

A content authoring tool is used to author content in layers of a collection of content blocks. A primary or base version (also referred to as a base layer or base level) is authored for a collection. The collection is customizable at one or more second or other successive levels (also referred to as authoring layers or levels) by authors adding new blocks in-between existing blocks at a successive layer—whether the surrounding blocks came from the base version or a second or more level. Authors can also hide blocks from the lower level.

[Level 1: Paragraph]

[Level 2: Added image]

[Level 1: Video]

[Level 1: Document]

[Level 2: Hide this Level 1 Document]

Although the authoring at this second level is distinguishable, the end result to end-users who are not authors, can be represented as a flat document without demarcation of levels such that it appears as a flattened, sequence of block content.

[Paragraph]

[Image]

[Video]

([hidden Document not displayed])

Each block is added with a calculated rank relative to the blocks surrounding it. A content block has predecessor ID and successor ID metadata to identify its flattened sequential predecessor and successor, who in turn also have similar metadata identifying theirs. When rendering a level of the document, each block is placed immediately after its known sequential predecessor. If a block has been hidden at any level, the block does not render. If when rendering, a block's predecessor is missing because it has been deleted, the block is placed directly before its recorded sequential successor. If neither a predecessor nor successor exist, the block is ordered using the rank that was calculated when it was first placed.

This content authoring tool algorithm working with a content management system is recursive enabling a situation like a curriculum author creating a national curriculum, creating a second level to localize the curriculum to a particular state, a third level managed by a customer to further customize, and even an end-user who wants to customize further for themselves or their audience, ad infinitum.

For example, automatic propagation of updates downstream may be made using a content authoring tool for a content management system in an update to instruction content made in authoring levels corresponding to a national level (U.S.A.), passed to a state level (Texas), to a city level (Austin), and then automatically incorporated in a lesson plan accessed by a teacher. A teacher may have previously created a lesson plan using existing content (a successive layer of a collection). The content management system automatically incorporates the downstream propagated updates made by authors in authoring layers using a content authoring tool into the lesson plan. When the teacher accesses the lesson plan, the updated content then appears in the lesson plan. In this way, a downstream user benefits from updates propagated from upstream sources, such as, entities at the national, state or local level who create updates for propagation by the content management system. These updates can be changes to educational curricula, standards, texts, textbooks, lesson plans or other content.

There are a number of advantages of a content authoring tool and content management system as described herein. First, the content authoring tool and content management system enables curriculum authors external and internal to manage base curricula, customize region-specific adaptations, distribute to customers who can further customize, and educators who can customize even more without much effort. This is a next-level customization algorithm and system than conventional content management systems provide.

### System and Online Platform

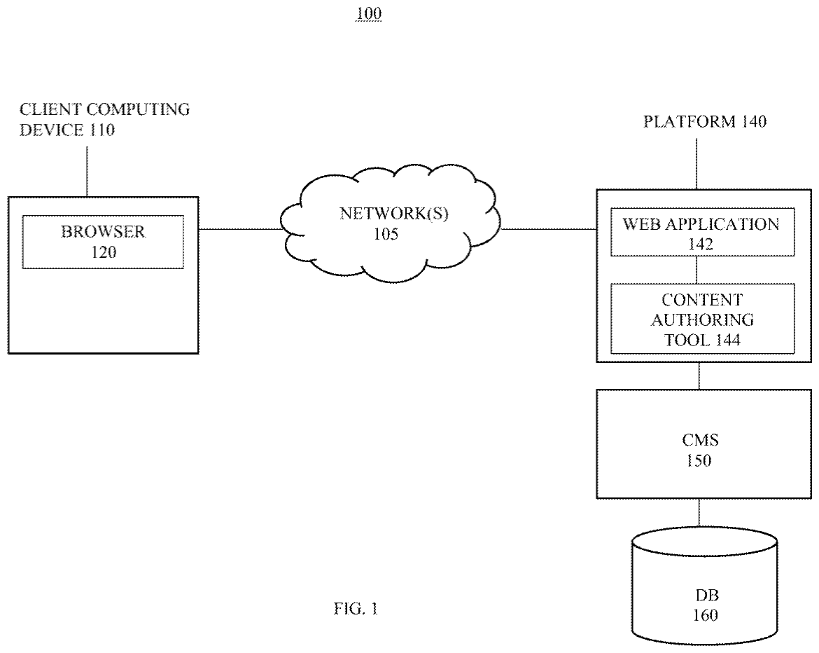

FIG. 1 is a diagram of a system 100 according to an embodiment of the present invention. System 100 includes an online platform 140 having a web application 142 and content authoring tool 144. Online platform 140 is coupled to a content management system 150 and one or more databases 160. One or more client computing devices 110 are coupled over one or more data networks 105 to online platform 140. Each client computing device 110 may include a browser 120. Content management system 150 manages storage and access to data stored in one or more databases 160. Each database 160 may be a relational database or other type of database.

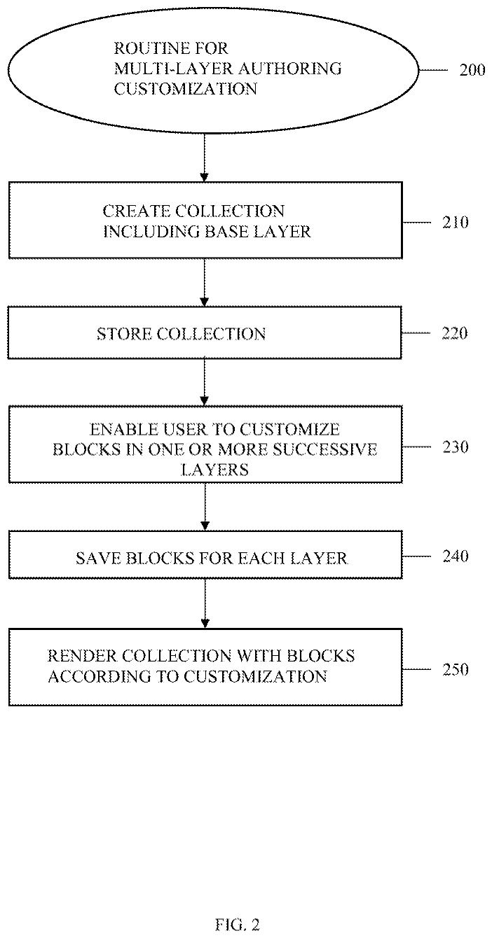

In operation, browser 120 may communicate over network(s) 105 to platform 140 and in particular may communicate with web application 142 and content authoring tool 144. Web application 142 controls operation and data communication between online platform 140 and client computing devices 110. Content authoring tool 144 may be configured to be in communication with or a part of web application 140. Content authoring tool 144 manages authoring of collections of data including enabling customization of content in one or more layers of content blocks. Examples of customization of content include enabling different users to add or remove content blocks in rendering layers of a collection. Each collection of data includes a graph structure having a base layer and one or more successive layers of content blocks. This allows different users to add, remove or rank different content blocks in each layer. In this way, different users according to their privileges or role may customize stored collections of data and what content in a collection is rendered to end users. The operation of system 100 including content authoring tool 144 is described further below with reference to routines and examples in FIGS. 2-5.

FIG. 2 is a flowchart diagram of a routine 200 for multi-layer authoring with customization of content in accordance with an embodiment (steps 210-250). In step 210, content authoring tool 144 creates a collection of data including a base layer. The base layer may be made up of one or more content blocks. Content authoring tool 144 may then store the created collection (step 220) in database 260.

For example, in step 210, a user (also called an author) of browser 120 may open web application 142 and initiate content authoring tool 144. Web application 142 may output one or more display screens or other user-interface elements to the author to allow selection of content for a collection. In response to an author's input at browser 120, content authoring tool 144 may create identifying information for the collection. The identifying information may include a collection name and graph structure information identifying a base layer and one or more successive layers of content blocks. Other metadata may be included to define properties of the content blocks in the base layer and other successive layers. The metadata for each content block includes data fields, such as, block ID, layer ID, and one or more customization control fields. Block ID may be text or numeric information identifying the block. Layer ID may be text or numeric information identifying the layer. The customization control fields can include one or more fields having data to control rendering of a content block, such as, add, remove, predecessor ID, successor ID, and/or rank. Add or remove data controls whether a content block is added or removed during rendering. Predecessor ID and successor ID identify respectively a predecessor block and a successor block, and control whether a content block is rendered after the predecessor block or the successor block. Content in a content block may be one or more of text, image, audio, video or other type of content. In one application content suitable for instruction in schools, universities, business, government or other settings is used.

Once an author has created a collection, content authoring tool 144 communicates with CMS 150 to instruct CMS 150 to store the created collection in database 160 (step 220). The stored collection may include the identifying information and metadata for the collection described above as well as the content blocks. The stored collection in database 160 may be stored in computer-readable memory on the same machine or different machines at the same or different locations depending on the database and storage architecture used.

In step 230, content authoring tool 144 enables a user (author) to customize content blocks in one or more successive layers. Content authoring tool 144 may communicate with web application 142 to output one or more display screens or other user-interface elements to the author to allow customization of content for a collection. In particular, content authoring tool 144 may enable the author to customize content blocks in one or more successive layers of a collection. For example, an author may input commands to add or remove a content block from a layer. An author may input commands to hide or edit a content block in a layer. An author may also input a command to rank an order of a content block or to place a content block relative to a predecessor or successor content block of a layer.

In step 240, content authoring tool 144 saves or updates content blocks including metadata for the content blocks representative of the customization in step 230. In step 250, content authoring tool 144 through web application 142 renders each layer of content blocks according to the metadata representative of the customization. In this way, a collection is rendered and output for display in browser 120 on client computing device 110 with customization of content provided by one or more authors.

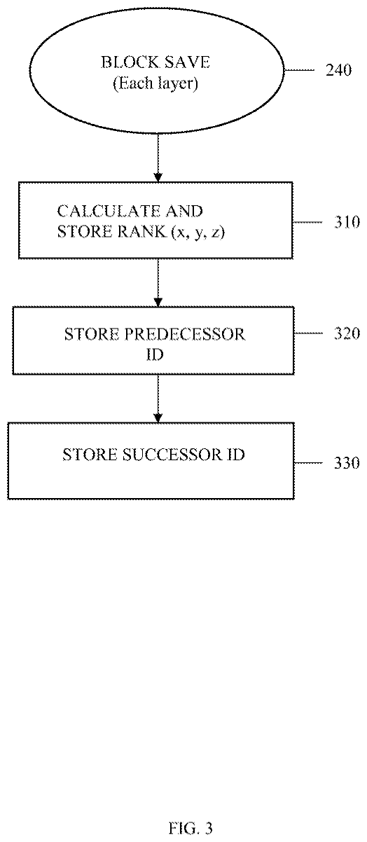

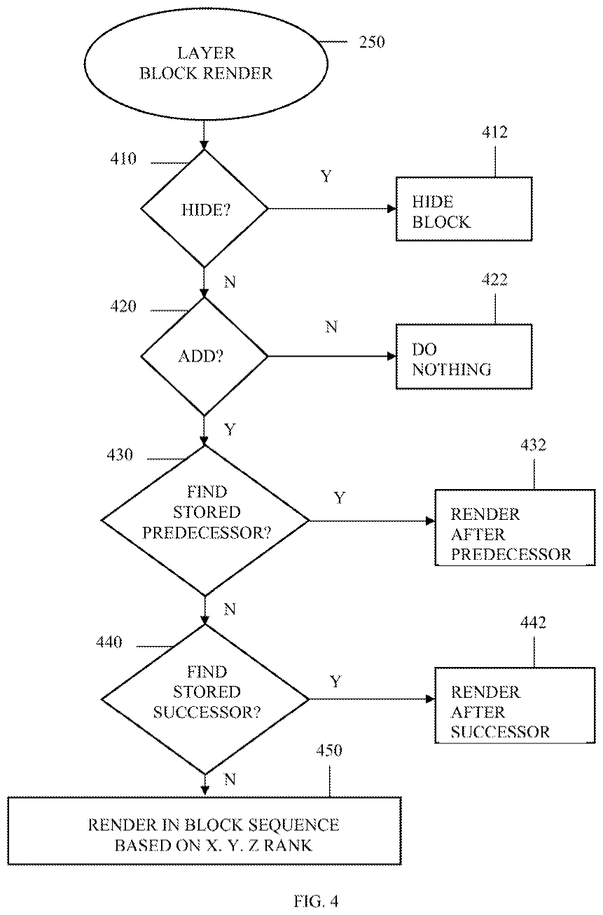

The operation of steps 240 and 250 is described in further detail with respect FIGS. 3 and 4.

As shown in FIG. 3, routine 240 is performed for each content block of each successive layer that is customized (steps 310-330). In step 310, content authoring tool 144 calculates and stores a rank for each content block. A rank for example may be identified by three coordinates (x,y,z).

In step 320, content authoring tool 144 calculates and stores a predecessor ID for a content block. For example, content authoring tool 144 may store the predecessor ID for the content block in a customization control field.

In step 330, content authoring tool 144 calculates and stores a successor ID for a content block. For example, content authoring tool 144 may store the successor ID for the content block in a customization control field.

As shown in FIG. 4, routine 250 is performed for each layer having content blocks to be rendered (steps 410-450).

During rendering, web application 142 evaluates customization control fields to determine which content blocks to render and what order to render or place content blocks on a display.

For example, in step 410, web application 142 reads whether a customization control field indicates to hide block. If yes hide, control proceeds to hide the respective content block and not include it in rendering of the collection on a display screen (step 412).

If no hide, web application 142 reads whether a customization control field indicates to add block (step 420). If no add, control proceeds to do nothing for the respective content block with respect to rendering (step 422). If yes add, control proceeds to evaluate stored predecessor ID or successor ID to identify predecessor and successive blocks (steps 430 and 440).

If a block is to be added, web application 142 reads whether a customization control field indicates a predecessor ID (step 430). If yes, control proceeds to render the content block after a predecessor content block identified by the predecessor ID (step 432).

If no, control proceeds to render the content block after a successor content block identified by successor ID (step 440). If yes, control proceeds to render the content block after a successor content block identified by the successor ID (step 442).

If neither a stored predecessor ID or successor ID are identified, then control proceeds to render the content block to be added according to a block sequence based on the rank value in the metadata (step 450).

The example above describes web application 142 performing rendering routine 250 including steps 410-450. In other examples, web application 142 communicating with browser 120 may perform rendering routine 250. Alternatively, browser 120 alone may communicate directly with a CMS 150 and perform routine 250.

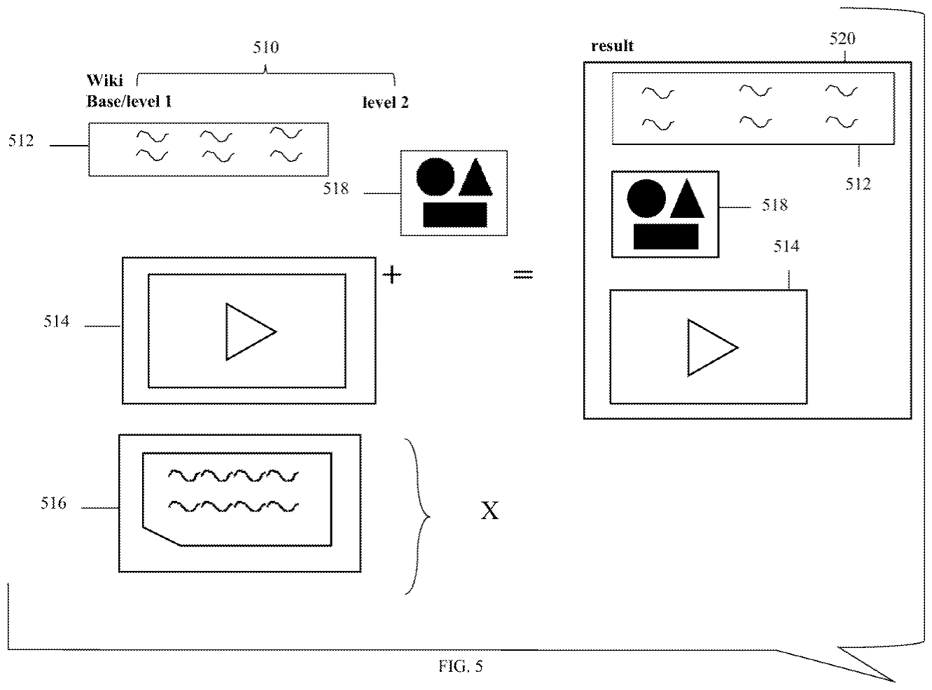

FIG. 5 shows an example data collection 510 stored and rendered in accordance with an embodiment. For example, collection 510 may have a base layer (level 1) and a successive layer (level 2). Level 1 has three content blocks 512, 514, and 516. Block 512 is made up of text. Block 514 includes a video file. Block 516 includes text. Level 2 is customizable as described herein. For example, an author may use content authoring tool 144 to add a content block 518 in level 2. An author also may choose to remove block 516 from level 1. During rendering, web application 142 evaluating customization control fields as described above with respect to FIG. 4 would then communicate with browser 120 to display a result 520 on a display screen (such as in a browser tab or window of the browser). Result 520 includes the customized content of the collection. In particular, result 520 includes content blocks 512, 518, and 514 as shown in FIG. 5. Block 516 is not included because the customization control field indicated remove block. Block 518 is added because the respective customization control field indicated add block. The order and placement of the blocks 512, 518 and 514 is determined according to rank or predecessor ID or successor ID information.

Upstream Authoring and Automatic Propagation to Downstream Users

In one application system 100 may be used with instructional content such as that incorporated in education curricula at different national, state and lesson plans. As described above, content authoring tool 144 working with a content management system 150 may be recursive enabling a situation like a curriculum author creating a national curriculum at a base level, creating a second level to localize the curriculum to a particular state, a third level managed by a customer to further customize, and even an end-user who wants to customize further for themselves or their audience, ad infinitum.

For example, automatic propagation of updates downstream may be made for a content management system in an update to instruction content made at a national level (U.S.A.), passed to a state level (Texas), to a city level (Austin), and then automatically incorporated in a lesson plan accessed by a teacher. A teacher may have previously created a lesson plan using existing content (a fourth layer of a collection). The content management system automatically incorporates the downstream propagated updates made by authors in authoring layers using a content authoring tool into the lesson plan. When the teacher accesses the lesson plan, the updated content from other authoring layers then appears in the lesson plan. In this way, a downstream user benefits from updates propagated from upstream sources, such as, entities at the national, state or local level who create updates for propagation by the content management system. These updates can be changes to educational curricula, standards, texts, textbooks, lesson plans or other content.

System 100 may be implemented on one more computing devices. In embodiments, browser 120 can be a commercially available web browser, such as, a CHROME browser available from Google Inc., an EDGE browser (or Internet Explorer) browser available from Microsoft Inc., a SAFARI browser available from Apple Inc., or other type of browser. Client computing device 110 can be any electronic computing device that can support a browser 120. A user can enter control inputs to browser 120 through a user interface (such as a keyboard, microphone, or touchscreen) at client computing device 110. For example, client computing device 110 can include, but is not limited to, a desktop computer, laptop computer, set-top box, smart television, smart display screen, kiosk, a mobile computing device (such as a smartphone or tablet computer), or other type of computing device having at least one processor and memory. In addition to at least one processor and memory, such a computing device may include software, firmware, hardware, or a combination thereof. Software may include one or more applications and an operating system. Hardware can include, but is not limited to, a processor, memory and user interface display or other input/output device.

In one embodiment, browser 110 can be coupled to one or more computer networks 105 as part of an online service. One or more client computing devices 100 are coupled over communication links to one or more networks 105. Platform 140 including web application 142 and content authoring tool 142 may be implemented on one or more servers. The servers can be any type of data server including but not limited to a server that can execute or support web application 142 and tool 144. One or more web servers can also be coupled to the servers to support World Wide Web protocols and services. Platform 140 is also coupled over communication links to one or more networks 105. Network(s) 105 can be any data network or combination of data networks, including but not limited to, a computer or telephony network, local area computer network, medium area network or the Internet.

One or more databases 160 stores collections of data including layers of content blocks and metadata as described herein. In one example, database 260 stores content blocks that includes one or more of text content, accessibility content, text-based image definitions (e.g., scalable vector graphic (SVG)), references to external raster image assets, and references to external objects (e.g., audio files, video files, and assessment items). In one implementation, database 260 can be a relational database used with a database management system that provides JSON support. Asset object storage devices can also be used with CMS 150 on any computer-readable memory device that stores objects. This can include images, audio files, video files, etc.

In operation, an author can point or navigate browser 120 to access web application 142 and content authoring tool 144. Authentication or other permissions may be needed to control access to application 142 and tool 144. For example, application 142 can send appropriate logic and data to browser 120 to configure the rules and operation of browser 120 to include functionality to support content authoring tool 144 and rendering as described herein.

During operation, browser 120 communicating with content authoring tool 144 can work online or offline to allow a user to customize content in authoring layers as described herein. Functionality of content authoring tool 144 can also be shared between browser 110 and application 142 to distribute processing and work required between client device 100 and servers on platform 140 as would be apparent to a person skilled in the art given this description.

### Online Service

In one embodiment, a content authoring tool and content management system, has described herein can be used in a computer networked system as part of a live online service. A computer networked system having the content management system and application can control presentation of education content on a display of a client computing device. One or more client computing devices may be coupled over communication links to one or more networks. A content management system may also be coupled to one or more databases. Network(s) can be any data network or combination of data networks, including but not limited to, a computer or telephony network, local area computer network, medium area network or the Internet.

In one implementation, a content management system may be implemented on one or more servers running on one or more computing devices. A server can be any type of data server including, but not limited to, a server that can execute or support an application interfacing on remote client computing devices. A web server can also be coupled to a server or can be a part of server. A server in a content management system can manage and access data stored in the databases.

### Further Embodiments and Example Implementations

Aspects of embodiments for an exemplary system 100 including platform 140 and web application 142 and content authoring tool 144 may be implemented electronically using hardware, software modules, firmware, tangible computer readable or computer usable storage media having instructions stored thereon, or a combination thereof and may be implemented in one or more computer systems or other processing systems.

Embodiments may be directed to computer products comprising software stored on any computer usable medium. Such software, when executed in one or more data processing device, causes a data processing device(s) to operate as described herein.

Embodiments of the present invention have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed. The breadth and scope of the present invention should not be limited by any of the above-described exemplary embodiments.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

1. A computer-implemented system for electronically propagating content to downstream users, comprising:
a content management system, implemented on at least one processor, configured to manage storage of collections of content blocks, wherein each collection includes multiple layers of content blocks including a base layer having at least one content block and at least one authoring layer customizable by one or more authors, and wherein the at least one authoring layer includes the at least one content block and one or more additional content blocks; and
a content authoring tool, implemented on at least one processor, coupled to the content management system and configured to generate metadata for each of the base layer and the at least one authoring layer, wherein the metadata for each of the base layer and the at least one authoring layer includes one or more data fields having block ID and layer ID information and one or more content customization fields, and wherein the metadata indicates whether a first user of the downstream users is to view the base layer or the at least one authoring layer.

2. The system of claim 1, wherein the content authoring tool is configured to communicate over a network through a web application with a browser at a remote computing device.

3. The system of claim 2, wherein the content authoring tool is configured to enable an author at the remote computing device to perform one or more modifications to a collection to add, remove, hide, or edit the at least one content block, the one or more additional content blocks, or a combination thereof, in the at least one authoring layer.

4. The system of claim 3, wherein the content management system updates the stored collection in accordance with the one or more modifications performed.

5. The system of claim 3, wherein the content authoring tool for each content block to be added to an authoring layer of a collection calculates a rank for each added content block relative to other surrounding content blocks in the collection, and generates predecessor ID and successor ID information for respective predecessor and successor content blocks surrounding the added content block in the same authoring layer.

6. The system of claim 3, wherein the content authoring tool creates identifying information for the collection and generates metadata for each content block in the base layer and successive authoring layers, wherein the successive authoring layers include the at least one authoring layer, and wherein metadata for respective content blocks in the successive authoring layers includes one or more data fields having block ID and layer ID information and one or more content customization fields.

7. The system of claim 6, wherein the one or more content customization fields include information to control rendering of a respective content block to the downstream users.

8. The system of claim 6, wherein the one or more content customization fields include one or more data fields having one or more of add, remove, predecessor ID, successor ID, or rank information to control rendering of a respective content block relative to other content blocks in an authoring layer in a display view on the remote computing device.

9. The system of claim 6, wherein the one or more content customization fields include one or more data fields having add, remove, predecessor ID, successor ID, and rank information to control rendering of a respective content block relative to other content blocks in the base layer, the successive authoring layers, or a combination thereof, in a display view on the remote computing device.

10. The system of claim 9, wherein the display view on the remote computing device comprises a display view within a browser tab or window of the browser.

11. The system of claim 10, wherein the browser renders output content of one or more collections received through the web application from the content authoring tool, and wherein the content authoring tool generates the output content to fulfill a browser request for a pertinent collection of the one or more collections including evaluating authoring layers of the pertinent collection and returning information identifying particular content blocks for rendering according to the stored metadata and content customization fields in the authoring layers.

12. The system of claim 9, wherein the content comprises education content including content on national, state or regional curriculum and each downstream user at a remote computing device automatically receives rendered content output by the content authoring tool through the web application which incorporates content customizations input by one or more upstream authors such that modifications to the education content in one or more collections made by the one or more upstream authors at a national or state level are automatically propagated by the content authoring tool to each downstream user of the education content in renderings of the one or more collections, whereby a downstream teacher or administrator at a regional or school level may view the one or more collections that automatically incorporate in display views rendered on a computing device to the downstream user the customized content of national, state or regional curriculum authored upstream at national, state or regional levels.

13. A computer-implemented method for electronically propagating content from an online platform having a web application with a content authoring tool to downstream users, comprising:
storing collections of content blocks in a database coupled to a content management system, wherein each collection includes multiple layers of content blocks including a base layer having at least one content block and at least one authoring layer customizable by one or more authors, and wherein the at least one authoring layer includes the at least one content block and one or more additional content blocks; and
electronically generating metadata for each of the base layer and the at least one authoring layer, wherein the metadata for each of the base layer and the at least one authoring layer includes one or more data fields having block ID and layer ID information and one or more content customization fields, and wherein the metadata indicates whether a first user of the downstream users is to view the base layer or the at least one authoring layer.

14. The method of claim 13, further comprising enabling an author at a remote computing device to perform one or more modifications to a collection of the collections to add, remove, hide, or edit content blocks in one or more of the multiple layers.

15. The method of claim 14, further comprising evaluating the multiple layers of pertinent the collection and returning information identifying particular content blocks for rendering in a remote bowser according to stored metadata and content customization fields in the multiple layers.

16. The method of claim 14, wherein the content comprises education content including content on national, state or regional curriculum stored in content blocks on the multiple layers, and wherein each downstream user at a remote computing device automatically receives rendered content output by the content authoring tool through the web application which incorporates content customizations input by one or more upstream authors such that modifications to the education content in one or more of the collections made by the one or more upstream authors at a national, state or regional level are automatically propagated by the content authoring tool to each downstream user of the education content in renderings of the collections, whereby a downstream user may view lesson plans of a teacher in the collections that automatically incorporate in display views rendered on a computing device to the downstream user the customized content of national, state or regional curriculum authored upstream at national, state or regional levels.

17. A computer-implemented system for electronically propagating content from an online platform having a web application with a content authoring tool to downstream users, comprising:
means for storing collections of content blocks, wherein each collection includes multiple layers of content blocks including a base layer having at least one content block and at least one authoring layer customizable by one or more authors, and wherein the at least one authoring layer includes the at least one content block and one or more additional content blocks; and
means for electronically managing generating metadata for each of the base layer and the at least one authoring layer, wherein the metadata for each of the base layer and the at least one authoring layer includes one or more data fields having block ID and layer ID information and one or more content customization fields, and wherein the metadata indicates whether a first user of the downstream users is to view the base layer or the at least one authoring layer.

18. The system of claim 17, wherein the means for electronically managing customization of content by authors further enables an author at a remote computing device to perform one or more modifications to a collection of the collections to add, remove, hide, or edit content blocks in the at least one authoring layer.

19. The system of claim 18, wherein the means for electronically managing customization of content by authors further evaluates the multiple layers of the collection and returns information identifying particular content blocks of the collection for rendering in a remote bowser according to stored metadata and content customization fields in the multiple layers.

20. A non-transitory computer-readable storage medium having control logic for causing at least one processor to electronically propagating content from an online platform having a web application with a content authoring tool to downstream users, comprising:
first control logic configured to enable storing of collections of content blocks, wherein each collection includes multiple layers of content blocks including a base layer having at least one content block and at least one authoring layer customizable by one or more authors, and wherein the at least one authoring layer includes the at least one content block and one or more additional content blocks; and
second control logic configured to enable electronic generating of metadata for each of the base layer and the at least one authoring layer, wherein the metadata for each of the base layer and the at least one authoring layer includes one or more data fields having block ID and layer ID information and one or more content customization fields, and wherein the metadata indicates whether a first user of the downstream users is to view the base layer or the at least one authoring layer.

21. The non-transitory computer-readable storage medium of claim 20, wherein the second control logic further enables an author at a remote computing device to perform one or more modifications to a collection of the collections to add, remove, hide, or edit content blocks in the at least one authoring layer.

22. The system of claim 7, wherein the one or more content customization fields include information to control rendering of the collection so that a first subset of the downstream users view the at least one authoring layer and a second subset of the downstream users view the base layer, another authoring layer, or a combination thereof.

23. The system of claim 1, wherein the one or more content customization fields include information to control rendering of the one or more additional content blocks to prevent a subset of the downstream users from viewing the one or more additional content blocks.
